(19) United States
(12) Patent Application Publication
(10) Pub. No.: US 2012/0138161 A1
(43) Pub. Date: Jun. 7, 2012

(54) TAPPING APPARATUS AND COMPRESSIBLE BOTTLE THEREFORE, AND A PREFORM FOR FORMING SUCH CONTAINER

(75) Inventor: Wolter Wolthers, Alphen a/d Rijn (NL)

(73) Assignee: HEINEKEN SUPPLY CHAIN B.V., 1017 ZD Amsterdam (NL)

(21) Appl. No.: 13/382,109

(22) PCT Filed: Jul. 2, 2010
(86) PCT No.: PCT/NL10/50420

§ 371 Date: Feb. 20, 2012

(30) Foreign Application Priority Data
Jul. 3, 2009 (NL) 2003133

(51) Int. Cl. B23B 41/08; B32B 1/04; B65D 1/02

(52) U.S. Cl. 137/15.12; 137/315.01; 215/40; 428/34.1

(57) ABSTRACT

Tapping assembly for beverages, comprising a pressure chamber and a pressurising device, wherein the pressure chamber comprises a lid closing off the pressure chamber at least partly, with an opening in said lid, and a container extending with a neck through said opening and a body extending inside said pressure chamber, wherein a first flange extending around the neck lies at a side of the lid facing the pressure chamber and at least one element extending from said neck lies at the opposite side of the lid, the device being provided with at least one closure element engaging said at least one element, forcing said element away from the lid and thereby pulling the first flange towards the lid for sealing the opening by at least the first flange.

The invention relates to a tapping assembly for beverages. The invention further relates to a compressible container and to a preform for forming such container.

EP1003686 discloses a tapping assembly for beverages, comprising a pressure chamber into which an at least partly compressible container can be inserted, having a dispensing opening outside the pressure chamber. The container has a neck to which a closure element is attached, provided as a part of the container. The closure element is sealed against the neck and extends outward from the neck. The pressure chamber is provided with an edge against which the closure element can seal for forming a closed pressure chamber, forming a pressure space around at least part of the container. A pump is connected to the pressure chamber, for pressurising the container, such that it is compressed, thereby expelling the beverage through the neck out of the container. Therefore the beverage can be expelled against gravity and the neck can be directed in any direction when dispensing the beverage.

This known tapping assembly has the disadvantage that the closure element has to be provided, which is expensive in for example manufacturing, mounting and discarding. Moreover, the minimal volume of the container when all beverage has been dispensed will be defined by the closure element. This is disadvantageous with respect to storage and transport upon removal and disposal, especially when the container is compressed in for example radial direction in stead of lengthwise.

EP 1626925 discloses a similar device, having a container extending in a pressure chamber, the neck with the dispensing opening of the container extending downward. Again a closure element extending outward from the neck is sealed against the neck. A lid is provided which has an opening sealing against the closure element and an outer periphery sealing against an edge of the pressure chamber. The closure element forms part of the wall of the pressure chamber. This known tapping assembly has the same drawbacks of a tapping assembly according to EP1003686. Moreover, the positioning of the container in the pressure chamber is disadvantageous.

An object of the present disclosure is to provide an alternative tapping device.

An object of the present disclosure is to provide a tapping assembly using a compressible bottle.

An object of the present disclosure is to provide a tapping assembly with a disposable, compressible container which is relatively cheap, compressible to a high extend and/or good recyclable.

An object of the present disclosure is to provide a compressible container for a tapping assembly for beverages.

An object of the present disclosure is to provide a preform for a compressible container.

An object of the present disclosure is to provide a method for using a compressible container in dispensing a beverage.

One or more or the objects as disclosed here above in random order or other objects can be obtained by a tapping device, container, preform and/or method according to this disclosure.

In a first aspect a tapping assembly according to this disclosure can comprise a pressure chamber and a pressurising device. The pressure chamber comprises a lid closing off the pressure chamber at least partly, with an opening in said lid. A container extends with a neck through said opening and with a body inside the pressure chamber. A first flange extending around the neck lies at a side of the lid facing the pressure chamber and at least one element extending from said neck lies at the opposite side of the lid. The lid is provided with at least one closure element engaging said at least one element, forcing said element away from the lid and thereby pulling the first flange towards the lid for sealing the opening by at least the first flange.

In a second aspect a container according to this disclosure can be for a tapping assembly and comprise a neck and a body. The neck can comprise a first flange extending outward and a second flange extending at least partially around the neck, wherein the first flange is closer to the body than the second flange. The first flange extends further outward from the neck than the second flange, such that the second flange can be pushed through an opening through which the first flange cannot be pushed.

In a third aspect a preform according to this disclosure can comprise a neck portion and a body portion. The neck portion comprises a first flange extending at least partially around the neck and a second flange extending at least partially around the neck, wherein the first flange is closer to the body portion than the second flange. The first flange extends further outward from the neck than the second flange, such that the first flange can be pushed through an opening through which the second flange cannot be pushed.

In a fourth aspect a method for tapping a beverage is discloses, wherein a lid of a pressure chamber is mounted on a neck of a container and the container is inserted into the pressure chamber, such that the lid closes off the pressure chamber at least partly. The container is pulled with a first flange against a side of the lid facing the pressure chamber and locked in that position, thereby sealing an opening in the lid through which the neck of the container extends.

For a better understanding of the present disclosure embodiments of a tapping device, container, preform and method shall be described hereafter, with reference to the drawings. The drawings show in:

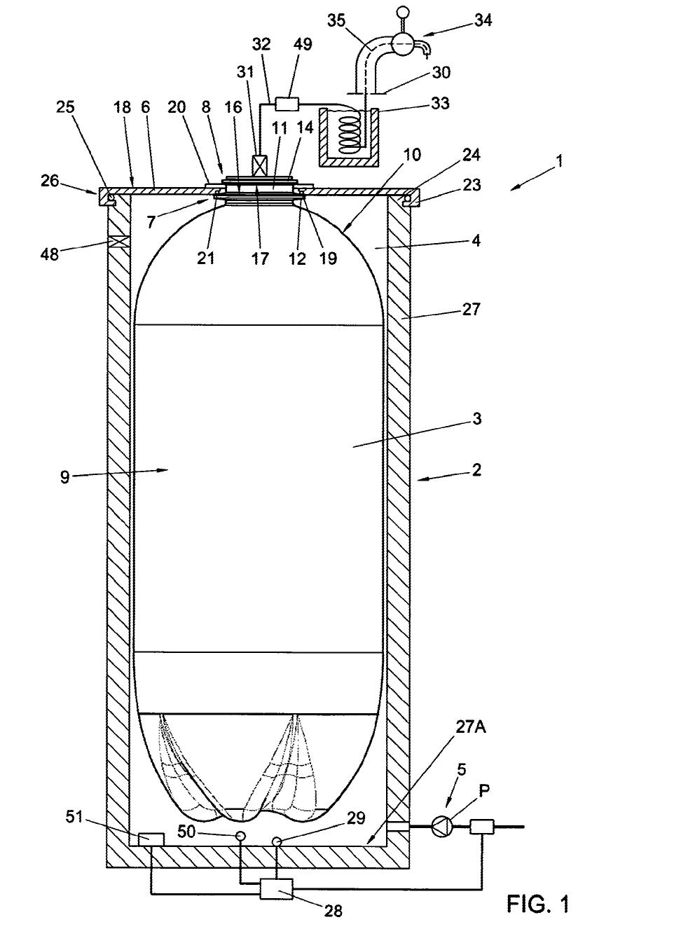

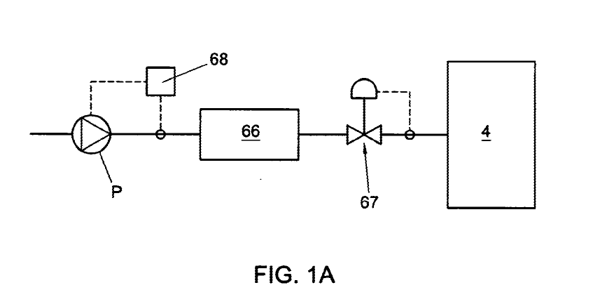

FIG. 1 schematically and in partial cross section a tapping assembly for a beverage;

FIG. 1A schematically a pressuring system;

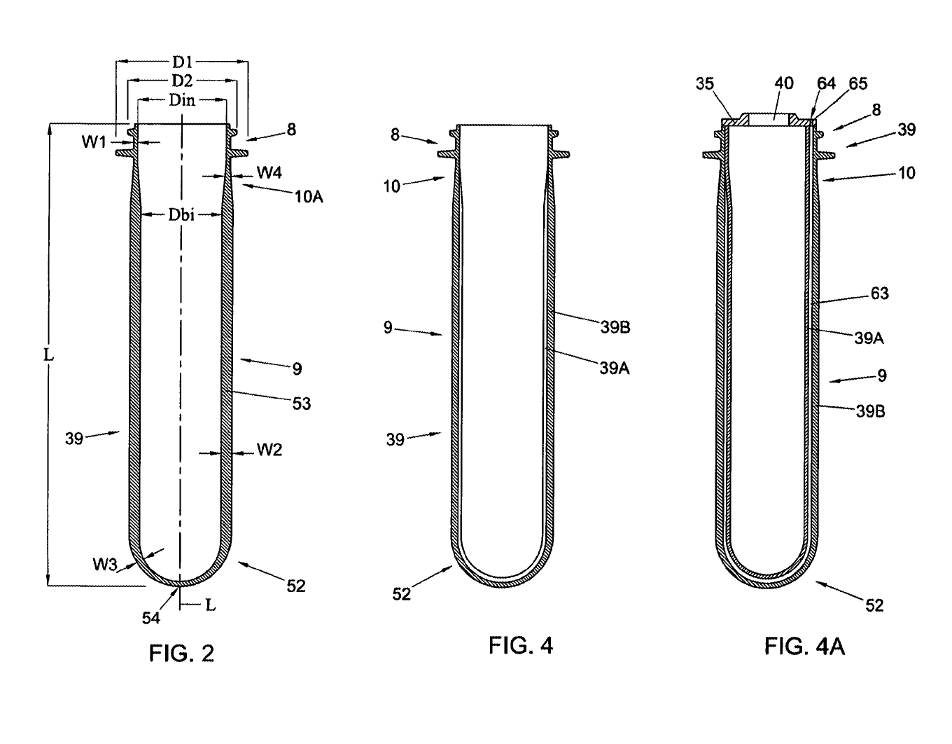

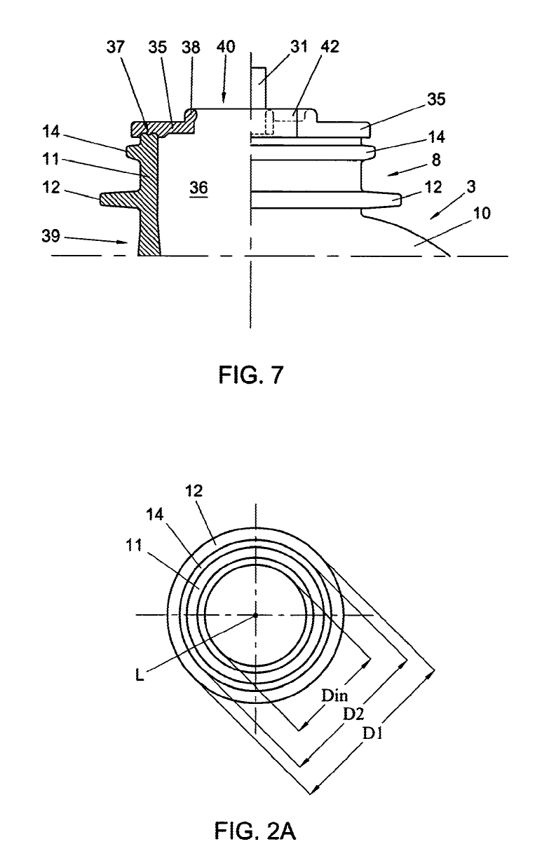

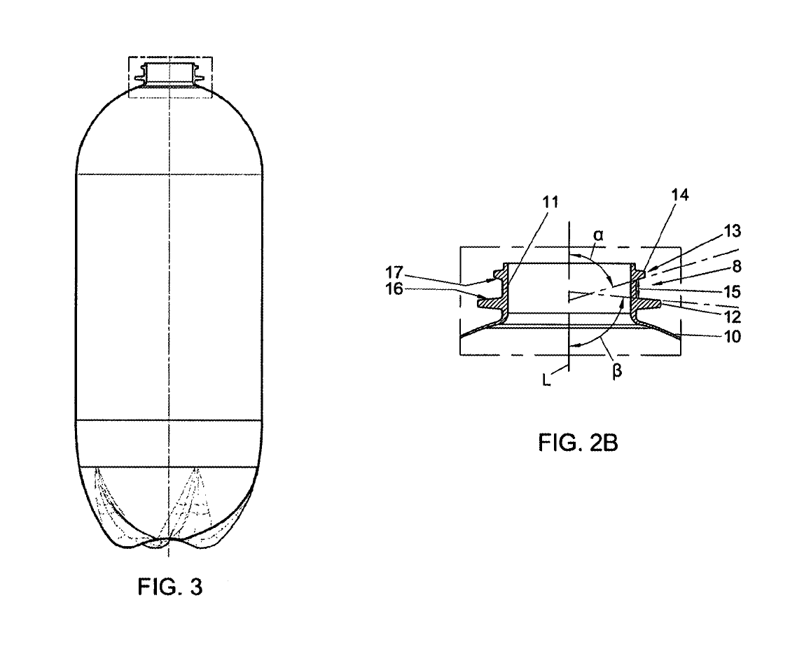

FIG. 2 schematically in cross section a preform for forming a blow moulded container;

FIG. 2A schematically in top view a preform of FIG. 2;

FIG. 2B schematically in enlarged cross sectional view part of a neck of a preform of FIG. 2 and of a container blow moulded from such preform;

FIG. 3 schematically in cross section a blow moulded container;

FIGS. 4 and 4a schematically in cross section alternative embodiments of a preform;

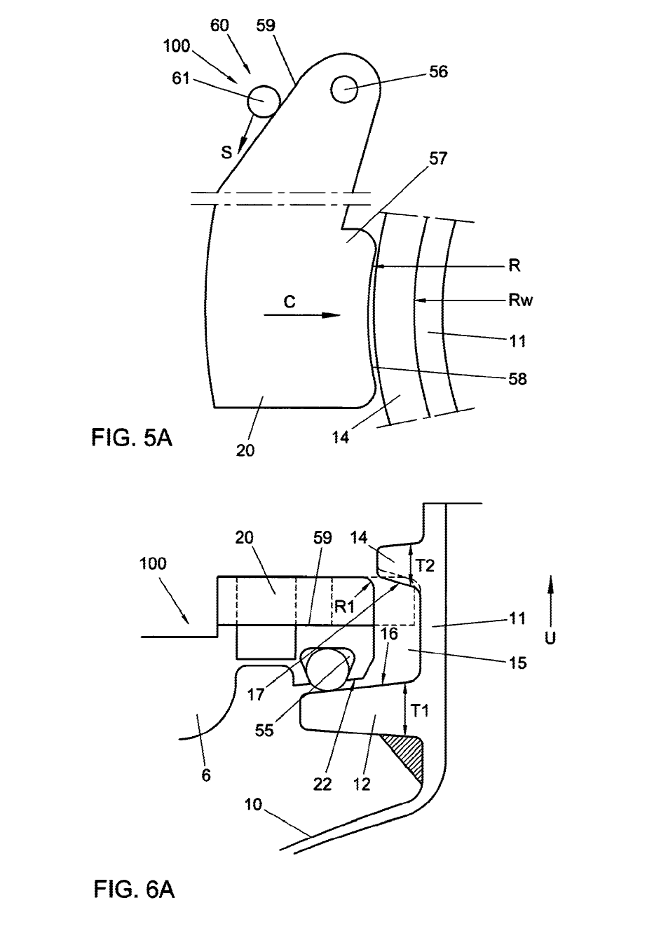

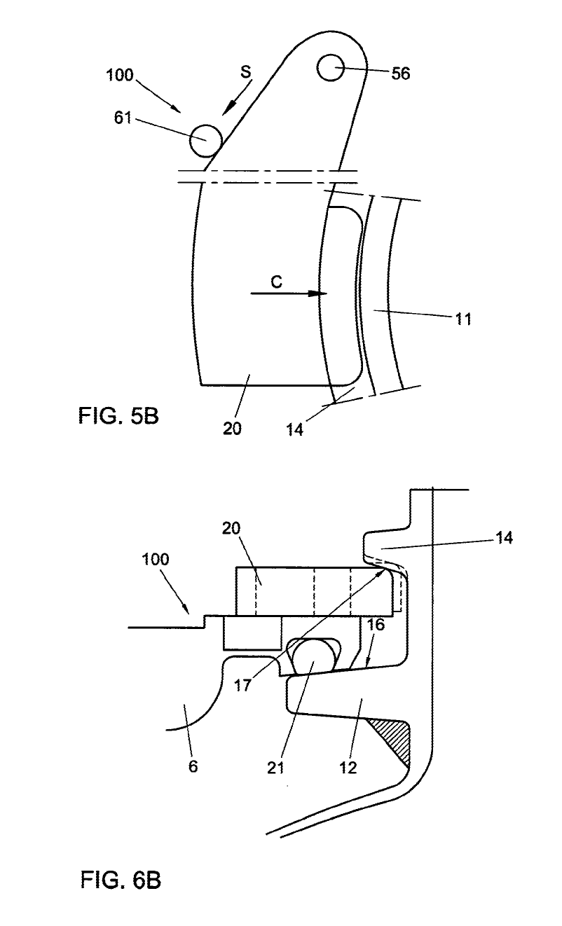

FIG. 5A schematically in top view part of a closure of a tapping assembly according to FIG. 1, in non sealed position;

FIG. 5B schematically in top view part of a closure of a tapping assembly according to FIG. 1, in sealed position;

FIG. 6A schematically in side view part of a closure of FIG. 5, in non sealed position;

FIG. 6B schematically in side view part of a closure of FIG. 5, in sealed position;

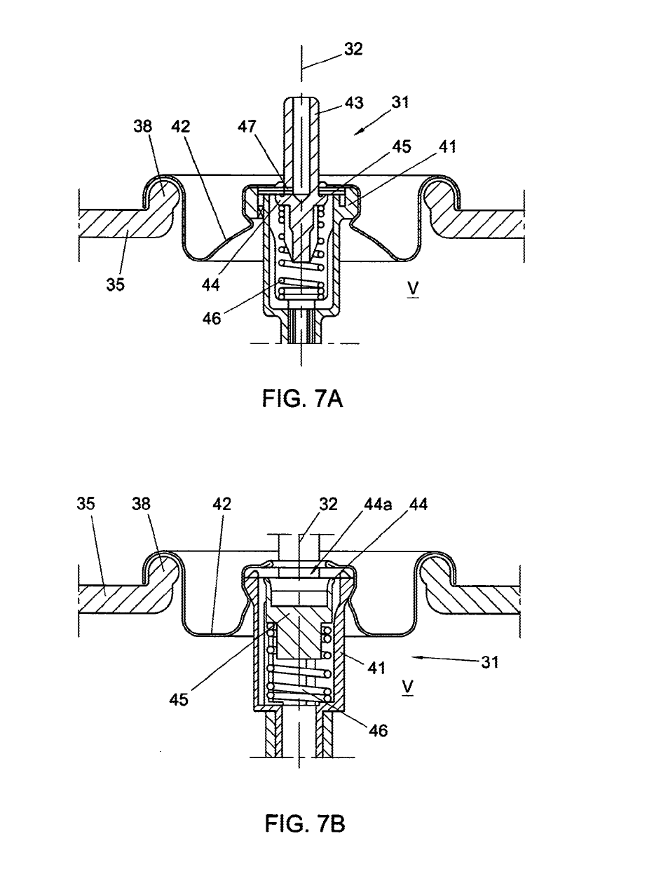

FIG. 7 on the left side schematically part of a preform including a neck portion, in cross section, with a closure ring, and on the right side in side view part of a container, blow moulded from the preform, with a vale attached to the closure ring;

FIG. 7A schematically a male type spray can type valve;

FIG. 7B schematically a female type spray can valve;

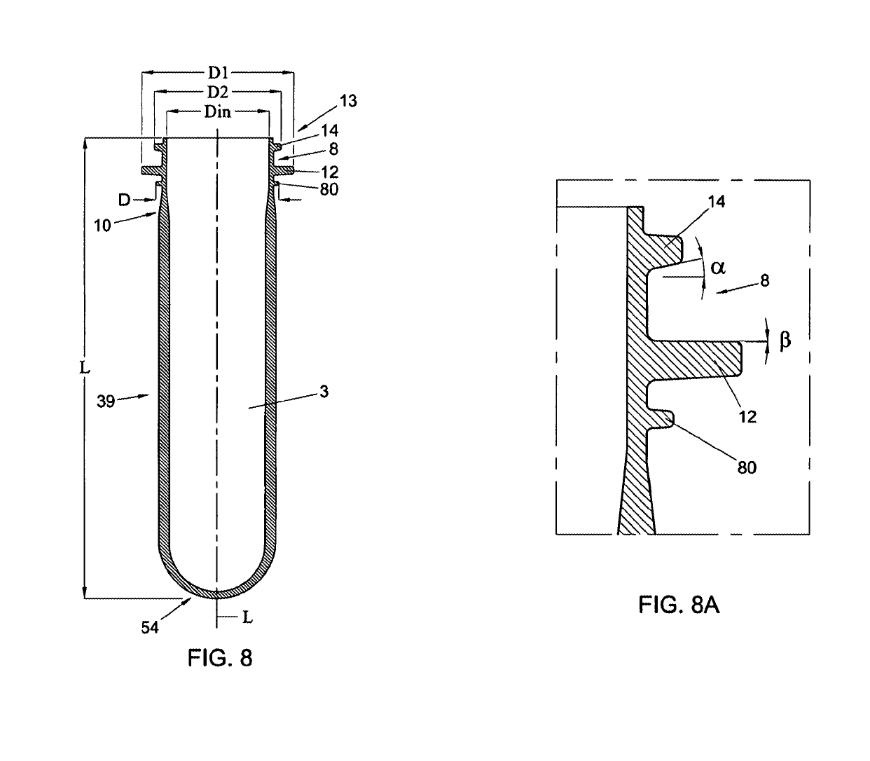

FIGS. 8 and 8A a preform and part thereof in a further alternative embodiment;

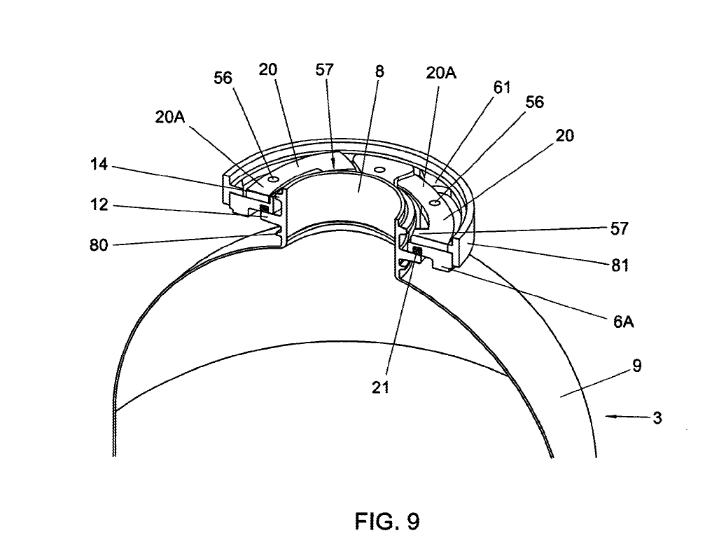

FIG. 9 in perspective cross sectional view part of a container with part of a lid; and

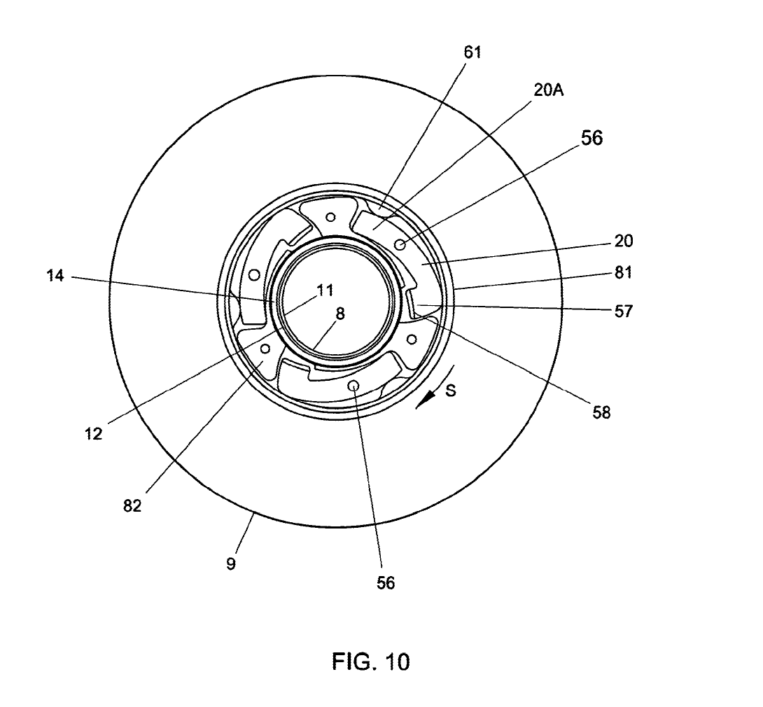

FIG. 10 in top view the container and part of the lid.

In this description the same or corresponding elements have the same or corresponding reference signs. The embodiments shown are examples only and should by no means be considered as limiting the scope of the disclosure in any way. In this description reference is made to storage and tapping of beverages, especially carbonated beverages such as beer or soft drinks. However, also different beverages or even other fluids can be stored in and dispensed from a container using a tapping assembly of this disclosure.

In this description a preform, which can also be a parison, has to be understood as at least including but not limited to an element injection moulded from plastic, to be blown into a blow moulded container. In this description preforms shall be described for blow moulding containers which basically have a bottle shape, including a neck portion, a body portion and a bottom portion, but it will be obvious to any skilled person that different shapes of containers can be made using different shapes of preforms falling within the same inventive concept. A preform can be single or multi layer. A multi layer preform can be manufactured using well known techniques, such as but not limited to co-injection, co-extrusion or over moulding. A multi layer preform can have a delaminating layer or layers.

In this description wording like about and substantially should be understood as meaning that variations of a given value it refers to are allowable within the given definition, which variations can at least be 5%, preferably at least 10% and more preferably at least 15% of the given value.

In this description preforms and containers will be discussed made of PET or PET blends. However, preforms and containers according to the present disclosure could also be made of different materials, blends or combinations of materials, such as but not limited to polypropylene or polystyrene, PEN, polyethylene and combinations thereof. In case of PET or PET blends, standard PET has to be understood in this respect as at least including PET without added additives for preventing crystallization of the PET during heating or stretching during blow moulding of a container.

In this description a compressible container is to be understood as at least including a container made at least partly of a plastic material or combination of materials, which can be compressed such that an internal volume thereof is reduced significantly, such that content of the container can be expelled from the container by said compression. Upon compression in a tapping apparatus the internal volume is preferably reduced to less than 2% of the original internal volume, more preferably less than 1%, more preferably to less than 0.6% of the original volume, without breaking or otherwise leaking of the container. A container can have a single wall, which shall be deformed during compression. A container can have a multi layer wall, in which the multi layer wall can be deformed substantially inward during compression, or in which one or more inner layers can be deformed substantially inward during compression, in which at least one outer layer can remain substantially in its original shape and/or dimensions. Compression can at least be understood as deformation in a radial and/or longitudinal deformation of a container or part thereof.

In this description reference shall be made to containers for holding and dispensing beverages, especially carbonated beverages such as beer and soft drinks. However other contents can be stored and dispensed using a container according to this description. The container and paraphernalia can be made disposable, which has to be understood as including but not limited to made for single use only, relatively cheap, recyclable, designed for convenience more than durability and/or optimal hygiene.

In FIG. 1 in partial cross section a tapping assembly 1 is shown, comprising a tapping device 2 and a container 3. The tapping device 2 comprises a pressure chamber 4 and a pressuring device 5. The pressuring device 5 is connected to or provided in the pressure chamber 4 for compressing the container 3. In an embodiment as shown in FIG. 1A a pressurising devices comprises a pump P connected to buffer 66. A reduction device 67 is provided between the buffer 66. A reduction device 67 is provided between the buffer 66 and the pressure chamber 4. A pressure sensor 68 is connected to the pump and the buffer 66. When the pressure drops in the pressure chamber 4 below a desired value, the reduction device 67 will open allowing high pressure gas, such as air, from the buffer 66 into the pressure chamber 4 to bring the pressure therein back to a desired level, closing off the reduction device 67 again. If the pressure sensor 68 senses that the pressure in the buffer drops below a desired value, the pump will be started to repressurise the buffer 66. For example the pump P will be started when the pressure in the buffer 66 drops below about 4.5 bar and stop at a pressure of about 6 bar. In an embodiment the pressuring device 5 can comprise a pump P. The tapping device 2 further comprises a lid 6 closing off the pressure chamber 4 at least partly. An opening 7 is provided in the lid 6.

The container 3 has a neck 8 and a body 9. The body 9 has a shoulder portion 10 which can be wider than the neck 8. As can more clearly be seen in for example FIG. 2, especially 2B, and 3, the neck 8 can be provided with a wall 11, such as for example but not limited to a cylindrical wall having a substantially circular cross section perpendicular to a longitudinal axis L of the neck 8 and/or container 3. The neck 8 is provided with a first flange 12 which can extend substantially radially outward all around the neck 8, from the wall 11 outward, as is shown, by way of example, in FIG. 2A for a preform from which a container 3 can be blow moulded. The first flange 12 can for example be provided near a shoulder portion 10. At least one further, second element 13, such as a second flange 14 can extend from the wall 11 substantially radially outward. In an alternative embodiment a number of such second elements 13 extend outward from the wall 11, for example teeth, ribs, bayonet elements or the like. The or each second element 13, such as the second flange 14 extends at a side of the first flange 12 opposite the body 5. A space or distance 15 is provided between a first surface 16 of the first flange 12 at a side facing the or each second element 13 and a first surface 17 of the or each further second element 13, facing the first flange 12. The first flange 12 extends radially further outward relative to the axis L than the or each second element 13.

An opening can be defined through which the neck 8 with the or each second element 13 such as the second flange 14 can pass, but the first flange 12 cannot. The opening 7 is such opening. As can be seen in FIG. 1 the neck 8 extends into and at least partly through the opening 7, such that the first flange 12 lies under the side of the lid 6 facing the pressure chamber 4, whereas the or a second element 13 or flange 14 lies in or above the opening 7. In an embodiment as shown in FIG. 1 the second flange 14 lies with its first surface 17 at a level above a main outer surface 18 of the lid 6 or above an upper edge 19 of the opening 7. The lid 6 is provided with at least one closure element 20 engaging the at least one element 13, such as the second flange 14, forcing said element 13, 14 away from the lid 6 and thereby pulling the first flange 12 towards the lid 6 for sealing the opening 7 by at least the first flange 12.

The lid 6 can, at the side of the pressure chamber 4, be provided with a seal 21, extending around the opening 7, as shown in more detail in FIG. 6A and B. The seal 21 can lie against the first surface 16 of the first flange 12. The seal 21 can be a sealing ring or a set of sealing rings, such as but not limited to concentric sealing rings. The or each sealing ring can for example be one or more O-rings, quad rings or the like. Preferably the seal 21 at least has an opening 22 through which the neck 8 with the or all elements 13 or flange 14 can pass, but the first flange 12 cannot. When the first flange 12 is pulled towards the lid 6 by forcing the or each element 13 away from the lid 6, for example as described above, in the direction U, then the seal 21 is compressed at least partly, sealing the pressure chamber 4. In the embodiments shown in the drawings the sealing 21 lies below the lid 6, meaning that pulling the elements 13 such as the second flange 14 away from the lid 6 is to be understood as mainly pulling the elements 13 or flange 14 upward. It should be understood that when the container 3 and pressure chamber 4 are held in a different position, for example with the axis L horizontally or the opening 7 facing down, the direction U of pulling shall be changed accordingly in orientation relative to a vertical direction, but will still be substantially away from the lid 6.

The lid 6 is provided with a peripheral area 23, which can be engaged by a free edge 24 of the pressure chamber, including a peripheral seal 25, for forming a peripheral closure 26 of the pressure chamber 4 such that upon closure of the lid 6 the peripheral seal 25 seals the pressure chamber 4 at the said peripheral area 23. Additional sealing of the opening 7 thus means that the pressure chamber 4 can be made sufficiently air tight.

In an embodiment the peripheral closure 26 of the lid 6 at the peripheral area 23 can be similar to the closure of a pressure cooker. The lid 6 and pressure chamber 4 or at least the device 2 can be provided with cooperating bayonet closure means and a sealing ring 25, gas tightly closing off the pressure chamber 4 at the peripheral area 23 of the lid 6. By way of example and not limiting in any way, for such closure 26 reference is made to EP0671140, disclosing closures that can be incorporated in a device according to the present disclosure for the peripheral closure 26 and sealing. Preferably the peripheral closure 26 is such that internal pressure in the pressure chamber 4 aids in sealing by forcing parts of the seal 25 closer against the lid 6 and/or the wall 27 of the pressure chamber 4, furthering the sealing at the peripheral area 23 at an increase of the pressure in the pressure chamber 4 and easing the opening and closing of the lid 6 when the internal pressure of the pressure chamber 4 is reduced to about atmospheric pressure. Other peripheral closures 26 can be used, which will be self evident to the skilled person.

A tapping device 1 can be provided with a control 28, connected to the pressurising means 5 for controlling the pressure inside the pressure chamber 4. The controller can be connected to a pressure sensor 29 in the pressure chamber. The controller can be provided with an algorithm for regulating the pressurising device 5, especially a pump P thereof, such that beverage can be dispensed from the container 3 at a desired pressure. In a preferred embodiment that desired pressure can be set by means of the control 28. During use preferably the pressure in the pressure chamber 4 is kept so high as to compress a container and keep the container in a compressed state. In an embodiment the pressurising device 5 is provided for pumping air into the pressure chamber for compressing the container or at least the body 5 thereof. In another embodiment a fluid such as water can be used for compressing the container 3. A pressure relief valve 48 can be provided for the pressure chamber 3. Such pressure relief valve 48 can be used as a safety, preventing over pressurising the chamber 4. The pressure relief valve 48 can alternatively or also be used for relieving pressure prior to opening the pressure chamber 4 for replacing a container 3.

The tapping device can be provided with a tapping line 32, connected to a valve 31 in or at the neck 8 of the container 3, which valve extends outside the pressure chamber 4 and is thus not influenced directly by pressure inside the pressure chamber 4. The valve 31 can be connected to the neck 8 using a closure ring 35. The closure ring 35 and/or the valve 31 can be connected to the neck 8 by any suitable means, such as but not limited to welding, gluing, snapping, clamping, press fitting, screw threads, bayonet means or the like.

A tapping line 32 can be provided with the container. In an alternative embodiment coupling means can be provided for coupling a tapping line 32 to the valve 31, allowing different tapping lines 32 to be used, depending on for example preference of a user, availability of tapping lines, desired cooling types, and the like. Adapters can be provided for fitting existing tapping heads to the valve 31.

The tapping line 32 can be led through cooling means, such as an in line cooler 33 or other cooling means known in the art, for cooling beverage in the tapping line. In the embodiment shown in FIG. 1 the tapping line 32 is led into or connected to a tapping cock 34. The tapping cock 34 can be mounted on the tapping device 1 itself. In another embodiment the tapping cock 34 can be mounted separately, for example on a counter 30 of a bar. Part of the tapping line or the whole tapping line 32 can be disposable. The tapping line 32 can be provided with the container 3 and if desired can be disposed of with the container 3. The tapping line can be connected to the valve 31 permanently. In another embodiment the tapping line 32 can be connected to the valve 31 by a user. In an embodiment the tapping line can be designed for repeated use such as a fixed tapping line 32 of a tapping installation. In such case the tapping line can be connected to the valve 31 by a suitable connector, such as a known tapping head or connector used for reusable beer kegs in outlets. The valve 31 can be a dedicated valve 31, such as for example a single valve for only allowing beverage to be dispensed from the container.

In another or the same embodiment the container can be cooled in its entirety or partly, by cooling the pressure chamber 4 or the apparatus 1, for example by providing a cooling means in or on the apparatus or by placing the apparatus at least partly in a refrigerator.

The valve 31 can in an embodiment be a spray can type valve, such as but not limited to valves as disclosed in NL1012802, NL1012921 or NL1012922, which applications are, with respect to the valves, considered to have been incorporated herein by reference. Examples of such spray can type valves have been schematically disclosed in FIG. 7A and 7B. In FIG. 7 an example of a closure ring 35 fitted to the neck 8 and extending over at least part of a dispensing opening 36 in the neck is shown, which is welded to a free edge 37 of the wall 11 of the neck 8. The closure ring 35 comprises an opening 40, preferably central to the ring 35, surrounded by an elevated edge 38. The closure ring 35 can be connected to the container 3 before or after filling the container with a beverage. In an advantageous embodiment the closure ring 35 is connected to a preform 39, as is shown in FIGS. 2, 4 and 7, left side, before blow moulding a container 3 from the preform 39. This means that the containers 3 can be blow moulded for example in line with a filling apparatus in a brewery or bottlers plant, without the necessity of having to connect the closure ring 35 to the container 3. Tools for heating and blow moulding the preform 39 into the shape of the container 3 can be inserted into the interior space through the opening 40 and the opening 36.

As is shown in FIG. 7A and 7B schematically, a spray can type valve 31, shown by way of example as a male variant thereof in FIG. 7A a female type in FIG. 7B, can be mounted using the closure ring 35. In this embodiment the valve 31 has a housing 41 which is fixed in a known manner in a plastic or metal clinch plate 42 which is clinched over the edge 38 in a known manner. The valve 31 of FIG. 7A comprises a hollow stem 43 with a sealing shoulder 44 forced against a sealing plate 45 by a spring 46. One or several substantially radial openings 47 extend through a wall of the stem 43 near a bottom thereof, which can be brought under the level of the sealing plate 45 by pushing down the stem 43 against the spring 46. This allows a beverage to flow from the interior space V of the container 3 through the stem 43 outward, for example into a tapping line 32 connected to the stem 43. In an embodiment of FIG. 7B a stem can be inserted through an opening 44A into a sealing plate or body 45 to press the plate or body 45 down against the spring 46, opening the valve 31 and allowing beverage to be dispensed.

In an embodiment a pressure sensor or flow sensor 49 can be provided in or around the tapping line 32, connected to the control 28. A temperature sensor 50 can be provided in or near the pressure chamber 4, connected to the control 28. A cooling apparatus 51 can be provided for the pressure chamber 4, for cooling the container 3 extending therein directly and/or indirectly. An example of such cooling device can be a Peltier element, air cooling, liquid cooler or any other suitable cooling means. The cooling device 51 can be provided in stead of or next to a cooling device 33.

FIG. 2 shows schematically in sectional side view a preform 39 for forming a container 3. The preform 39 has a neck 8 which is substantially the same as the neck of the container 3 blow moulded there from, since the neck 8 will during blow moulding not deform significantly. The preform 39 further comprises a body forming portion 9 and a shoulder forming portion 10A, extending between the neck 8 and the body forming portion 9. The body forming portion is closed off at the end opposite the neck 8 by a bottom forming portion 52. The wall 11 of the neck 8 has a first thickness W1, the wall 53 of the body forming portion 9A has a second thickness W2 and the bottom forming portion 52 has a third thickness W3, whereas the shoulder forming portion 10A has a fourth thickness W4. The thicknesses W are measured substantially perpendicular to the surface thereof and are not necessarily constant for each of the parts 8, 9A, 10A, 52. In the embodiment shown the first thickness W1 is smaller than the second thickness W2, whereas the third thickness becomes smaller from the lower end of the wall 53 of the body forming portion 9A toward an apex 54 of the bottom forming portion 52. The thickness W4 transforms steadily from the first thickness W1 at the lower end of the neck 8 to the second thickness W2 of the upper end of the wall 53 of the body forming portion 9A.

Such shapes and wall thicknesses are in general known from the prior art of preforms for blow moulding bottles. In a preform according to the present disclosure the neck 8 is provided with a first and second flange 12, 14 as previously disclosed. The second flange 14 can in an embodiment extend all the way around the neck 8, as for example shown in FIG. 2A. In an alternative embodiment the second flange 14 can be divided into a number of elements 13 spaced by gaps in between, as long as the container or at least the neck 8 can be pulled relative to the lid 6 by the said remaining element(s) 13 or the flange 14 to pull the first flange 12 towards the lid 6. As indicated before, the first flange 12 extends further outward, in radial direction relative to the axis L, than the second flange 14 or elements 13, especially such that the seal 21 can pass the neck 8 and the second flange 14 or element(s) 13, in order to abut the first surface 16 of the first flange 12 when the lid 6 is placed over the neck 8.

As is shown in FIG. 2B, 3, 5 and 6 especially, the first surface 17 of the second element or elements 13, such as the flange 14, can be inclined relative to the longitudinal axis L at an angle α. The first surface 16 of the first flange 12 can be inclined relative to the longitudinal axis L at an angle β. The angle α can for example be between 90 and 30 degrees. In an embodiment the angle α can be between 85 and 60 degrees. In an embodiment the angle α can be between 80 and 70 degrees, for example about 75 degrees. The angle β can for example be between 90 and 30 degrees. In an embodiment the angle β can be between 90 and 60 degrees. In an embodiment the angle β can be between 90 and 75 degrees, for example about 85 degrees. Preferably the surfaces 16, 17 are inclined such that the distance 15 between the surfaces increases in radially outward direction. At least the inclination of the first surface 17 of the second flange 14 or element(s) 13 can have the advantage that when a closure element 20 is inserted against said first surface 17 and moved inward, in the direction C, towards the wall 11, the surface 17 will be forced away from the surface 18 of the lid 6.

In FIG. 5A and 6A schematically in enlarged view part of a closure device 100 is shown, for locking the neck 8 in the opening 7 and sealing the opening 7, in non sealing position, in top and side view respectively. FIG. 5B and 6B shown corresponding views, in sealing position. The closure device 100 comprises at least one closure element 20. In the embodiment shown by way of example only the closure element 20 is moveable over part of the surface 18 of the lid or at least the edge 19 of the opening 7, between a first position shown in FIG. 5A and 6A and a second position shown in FIG. 5B and 6B. Preferably a number of elements 20 is provided around the opening 7, preferably simultaneously movable between the first and second positions. In the embodiment shown in FIGS. 5 and 6 the or each element 20 is rotatable around an axis 56 extending from the lid 6. The element 20 has a head 57 spaced apart from the axis 56. The head has an edge 58 at the side facing the wall 11 of the neck 8 and lies on a for example substantially flat surface part 59 of the lid 6. The edge 58 is preferably rounded both in top view, forming a hollow edge 58 with for example a radius R substantially similar to the radius Rw of the outer surface of the wall 11, and in side view, at the side facing away from the surface 59, having a radius R1 which can be relatively small. The radius R1 mainly serves to prevent the edge 58 from penetrating into the material of the element 13 or second flange 14 when moved from the first to the second position. In the embodiment shown an operating means 60 is shown, as a pin 61 by way of simplification, which can be at a fixed distance from the longitudinal axis L and can be moved along an outer surface 59 of the element 20 in a rotational direction S around the axis L. The surface 59 extends preferably not parallel to the path of movement of the pin 61, such that by moving the pin 61 in said direction S the element 20 will be rotated inwardly around the axis 56, in the direction C. This will result in the edge 58 being forced under and along the first surface 17 of the second flange 14 or element(s) 13, pushing this in the direction U, pulling along the first flange 12, which will thus be pulled against the seal 21 with the first surface 16, compressing the seal 21 at least partly and forming an air tight seal of the opening 7.

In the schematically shown embodiment of FIGS. 5 and 6 the lid 6 rests with the peripheral edge 19 of the opening and especially with the seal 21 on the first surface 16 of the first flange 12. The seal 21 is in this position largely undeformed. The seal can for example partly be enclosed in a groove 55 at the side facing the pressure chamber 4, in order to lock the seal 21 in position. Other means can be provided to that end, for example but not limited to gluing or welding the seal into place, screwing, clamping or otherwise locking the seal 21 into place. As can be seen in FIG. 6A extends the seal 21 at least partly out of the groove. The seal 21 can be made of any suitable material, such as but not limited to rubber, synthetic rubber or elastomeric material. The seal 21 can in another embodiment be an inflatable seal, for example air or water inflatable.

As can be seen from for example FIG. 1 the container 3 can be born by the lid 6, allowing the space between the container 3 and the wall 27 and bottom 27A of the pressure chamber 4. This can provide for the advantage that changes in the dimensions of the container 3, for example due to temperature changes can be allowed easily. Moreover, since support of the container 3 by the wall and/or bottom is not necessary, compression of the container is possible in any direction. In the present disclosure it has been recognised that the neck 8 does not deform significantly and that therefore the flanges 12, 14 or the flange 12 and element(s) 13 can be used both for securing the container 3 in the pressure chamber 4 and for closure of the pressure chamber 4. This obviates the necessity of additional elements to be provided on the container 3, which can make the container and tapping device easier to produce and/or use, less expensive, better recyclable and/or lighter and better compressible and/or compressible to a smaller overall volume.

In FIG. 4 an alternative embodiment of a preform 39 is disclosed, which is multi layered. The preform 39 can be co-injection moulded or coextruded, but in a preferred embodiment the preform 39 is assembled from at least an inner preform 39A and an outer preform 39B. The inner preform 39A and outer preform 39B can be injection moulded separately and then assembled into the preform 39, which can be seen as a preform assembly. In another embodiment the inner preform 39A can be injection moulded and then the outer preform can be injection moulded onto the inner preform, or vice versa. This can be done in a 2K injection moulding technique and appropriate mould. When two preforms 39A, B are used, each can be moulded with a smaller wall thickness, reducing cycle times for producing the preform 39 considerably. Moreover, each of the preforms can be made of the most appropriate material. For example the inner preform can be made of virgin material such as PET, whereas the outer preform can be made of recycled material, for example recycled PET or a cheaper material. Different preforms 39A, B can be provided with different coatings and/or different additives. For example the inner preform can be made of a plastics material comprising a scavenger, especially for O₂, whereas the outer preform can for example be free of such additive. The outer preform can be provided with a colorant, whereas the inner preform can be free of such additive. Obviously this can be changed over too. The inner preform can be made thinner than the outer preform or vice versa.

In an embodiment shown in FIG. 4A a multi layered preform 39 is provided in which between an inner preform 39A and an outer preform 39B a space or void 63 is provided, shown in exaggerated width, which can be filled with a fluid such as a gas, for example with air or with an inert gas such as N₂. When air is used preferably the inner preform 39A is provided with means to prevent oxidation of a beverage in a container 3 blown from such preform, for example by providing a scavenger for O₂ in the plastic of the preform 39A or by providing a protective layer on and/or in the preform 39A. In this embodiment the space or void 63 can be closed off to the environment, for example by the necks 8 of the preforms closing off against each other. This can for example be obtained by crimping the outer neck onto the neck of the inner preform 39A. In another or the same embodiment a closure ring 35 can be provided as previously described. In the closure ring 35 in an embodiment there can be an additional opening 64 opening into the space or void 63. This opening 64 can be closed off by a valve or, preferably, a seal 65, for example a breakable or pierceable seal. In an embodiment the space 63 can be pressurised or made vacuum, such that the rigidity of the container is increased relative to the rigidity of the container when the space 63 is at atmospheric pressure. Before compressing the container the space 63 can be brought into communication with the environment, for example by piercing the seal or opening the valve in the opening 64, such that atmospheric pressure will be obtained in the space 63. This will easy compression of the container 3 in the chamber 4, whereas during transport and storage the container will be highly rigid and resistant to compression. In a multi layered embodiment the outer preform can be made more resistant to for example breaking, whereas the inner container can be provided with barrier properties, be more rigid and stronger or have other advantageous properties. In an embodiment the closure device 100 can for example be designed to open the opening 64 when locking the neck 8 of the container 3 into position within the opening 7.

A container 3 according to the present disclosure can have a relatively large volume, for example at least about 5 litres, preferably more than about 10 litres, for example between about 10 and 20 litres, making it easy to handle within load carrying regulations. In an embodiment the container can have a larger volume, for example between about 17 and 40 litres. In an embodiment the container can have a volume of about 17 litres, such that the apparatus 1 can be sized to fit in a refrigerator for about 20 litre kegs or under a bar.

In an embodiment of the preform 39 and the container 3 blow moulded there from, which is only given by way of example and should by no means be understood as limiting the scope in any way, the neck 8 can have a substantially circular cross section having an inner diameter Dᵢₙ of about 54 millimetres, whereas the body forming portion of the preform 39 can have a substantially circular cross section having an internal diameter D_{bi} of about 50 millimetres. The overall length L of the preform 39 can for example be about 278 millimetres, the neck having an axial length, measured along the axis L of about 22 millimetres, the shoulder forming 10A portion having an axial length of about 28 millimetres. The bottom forming portion 54 can have a radius of about 30 millimetres.

In an embodiment of a container 3 or preform 39 the first flange can have a diameter D1, the second flange 14 a diameter of D2, wherein the second diameter D2 can be the same for the or each element 13 measured perpendicular to the axis L. The first diameter D1 can be at least about 8 millimetres larger than the second diameter D2. In an embodiment the first diameter D1 can be about 14 millimetres larger than the second diameter D2. In any case the first diameter D1 is preferably so much larger than the second diameter D2 that the seal 21 can lie on a part of the first flange 12 extending radially outside the second flange 14 or elements 13, seen in top view as shown in FIG. 2A. In a non limiting embodiment the first diameter D1 can be about 80 millimetres, whereas the second diameter D2 can be about 66 millimetres.

In a non limiting embodiment the first width W1 can be about 1.5 millimetres, the second width W2 about 6.2 millimetres. The third width W3 can than be for example between about 6.2 millimetres and about 3 millimetres, whereas the fourth width can then be between about 1.5 and about 6.2 millimetres. In another non limiting embodiment the first width W1 can be about 1.5 millimetres, the second width W2 about 4.4 millimetres. The third width W3 can than be for example between about 4.4 millimetres and about 3 millimetres, whereas the fourth width can then be between about 1.5 and about 4.4 millimetres. Obviously other widths can combinations of widths can be used.

In a non limiting embodiment the thickness T1 of the first flange 12 can range from about between 6 and 4 millimetres, for example about 5 millimetres near the wall 11 to between about 5 and 3 millimetres at the free edge thereof. In a non limiting embodiment the thickness T2 of the second flange 14 or element(s) 13 can range from about between 5 and 3 millimetres, for example about 4 millimetres near the wall 11 to between about 4 and 2 millimetres at the free edge thereof. In a non limiting embodiment the distance 15 between the first surfaces 16, 17 can be between about 6 and 10 millimetres, for example about 8 millimetres near the wall 11.

In an embodiment the flange 12 and/or element(s) 13 can be provided separately from the container and be placed on the neck of the container, or on the preform.

In FIGS. 8 and 8A an alternative embodiment of a preform 39 for use in the invention, which has a first flanges 12, a second flange 14 and a third flange 80 or a first and third flange 12, 80 and elements 13, wherein the third flange 80 is at the side of the first flange 12 facing away from the second flange 14 or elements 13. The third flange is thus closer to the body 9 of the preform 39 and container 3 to be blow moulded there from than the first flange 12. The third flange 80 preferably is concentric with the first flange 12 around the axis L and can have a smaller diameter D than the first flange 12 and even than the second flange 14 or elements 13. In the embodiment shown the third flange 80 can be a few millimetres below the first flange, for example but not limited to about 3 to 6 mm, measured along the wall 11. The third flange 80 can add to the stability, especially shape and size stability of the neck 8. In FIG. 8 at an enlarged scale part of the neck is shown, showing the first and second flange 12, 14 and the third flange 80. Such third flange 80 can be used in any preform or container as disclosed herein or covered by the disclosure. As can be seen in this embodiment the angle a can be relatively big compared to the angle β, for example about 20 to 40 times, such as but not limited to about 30 times. The angle β can for example be chosen such that it is sufficient for draft of a mould part for forming the neck, pulled away side ways, for example about 1 degree or less. Obviously any angle can be chosen within the description for α and β.

FIG. 9 shows in cross sectional perspective view part of a container with a neck 8 and part of a lid or closure element to be used therewith, which comprises the elements 20 and pins 61, here shown as cam followers 61. FIG. 10 shows the same embodiment, from a top view. In FIGS. 9 and 10 the elements 20 are shown in an “open” position, such that the neck 8 of the container can be inserted in between these elements 20 or can be removed there from. As is clear from the figures the first flange 12 cannot pass through the opening 15, whereas the second flange 14 can. Along an outer periphery of a base element 6A, which can be a part of the lid 6 or can be connectable thereto, a ring 81 is provided, rotatable around said periphery. At an inner side of the ring 81 the cam followers 61 are provided, which can contact the elements 20 in a way similar to FIGS. 5 and 6. In this embodiment the axis 56 is placed spaced apart from both ends of the element 20, such that a rear part 20A of the element extends beyond the axis 56 seen from the part 57 thereof. The cam followers 61 can be moved against this part 20A, such that the element 20 or at least the surface 58 is moved away from the neck 8 or at least in a direction away from the axis L, locking them in this position, until the ring 81 is rotated in the direction S, forcing the cam followers 61 against the part of the element 20 to forced the surface 58 inward, towards to axis L, under the elements 13 or flange 14. Between the elements 20 fixed elements 82 are provided for limiting the rotational movement of the ring 81, since the cam followers 61 will block further rotation by contacting these elements 82.

A tapping assembly can for example be used as follows.

A container 3, blow moulded from a preform 39, filled with a beverage and closed by at least a valve 31 is provided to a user. The user can push the lid 6 with the opening 7 over the neck 8 of the container, until the lid rests on the first flange 12. The neck 8 can be locked into place, for example by the closure element(s) 20 operated by the closure device 100. The container 3 can be placed inside the pressure chamber 4, such that the lid 6 fits on the pressure chamber 4 and can be closed and sealed. This leads to a gas tight and pressure resistant pressure chamber 4. Then the tapping line 32 can be connected, for example to the valve 31 and/or to a tapping cock 34. The pressure chamber 4 can be pressurised by the pressurising device 5, pumping air into the pressure chamber 4, thus compressing the container 3. The valve 31 can be periodically, on demand or preferably permanently be opened, such that beverage can be dispensed from the container under pressure, due to the compression of the container 3. After sufficient dispensing of beverage, the then emptied container 3 can be removed from the pressure chamber and released from the lid 6, such that it can be discarded. If the tapping line 32 or part thereof is disposable it can be disposed off, preferably together with the container 3.

The invention is by no means limited to the embodiments shown in the drawings or discussed in the description. Many variants are possible within the scope of the claims or disclosure. For example can the container be formed in a different way and can it be pulled against the lid in a different manner, for example by engaging the closure ring in stead of or together with the second flange 13. In that sense the closure ring can form the second flange 14 or element 13. The compression of the container can be obtained in a different manner, for example at least partly by mechanical means. In a multi layered container air can be inserted into the space between the layers of the container for dispensing the beverage. The closure elements or closure device can be designed differently for pulling the first flange against the lid, compressing the seal. A tapping device can be connected directly to the valve 31. In stead of a valve 31 a seal or lid can be provided closing off the neck 8. Cooling means can be provided in a different manner, as can the pressuring device. Other materials can be used for a container, which can be manufactured in a different appropriate manner.

These and many other variations, including but not limited to combinations of parts of the embodiments disclosed are considered to have been disclosed in this disclosure.

1. Tapping assembly for beverages, comprising a pressure chamber and a pressurising device, wherein the pressure chamber comprises a lid closing off the pressure chamber at least partly, with an opening in said lid, and a container extending with a neck through said opening and a body extending inside said pressure chamber, wherein a first flange extending around the neck lies at a side of the lid facing the pressure chamber and at least one element extending from said neck lies at the opposite side of the lid, the device being provided with at least one closure element engaging said at least one element, forcing said element away from the lid and thereby pulling the first flange towards the lid for sealing the opening by at least the first flange.

2. Tapping assembly according to claim 1, wherein the body of the container is compressible by pressure provided in the pressure chamber by the pressure device.

3. Tapping assembly according to claim 1, wherein the first flange extends further from a longitudinal axis of the neck of the container, measure perpendicular to the longitudinal axis, than the or each said element, preferably such that the neck and the or each said element extending from said neck can pass through said opening but said first flange cannot.

4. Tapping assembly according to claim 1, wherein the at least one element extending from the neck is a second flange, wherein the first and second flange are preferably substantially circular and concentric, wherein the first flange is larger than the opening in the lid, such that it cannot pass through the opening, wherein the second flange is smaller than the opening, such that it can pass through the opening.

5. Tapping assembly according to claim 1, wherein the container is a blow moulded container, preferably having a content of at least 5 litres, more preferably at least about 10 litres, especially about 10, 20 or 30 litres.

6. Tapping assembly according to claim 1, wherein the at least one closure element is a wedge, movable over at least part of the opening in the lid, between the lid and the at least one element extending from the neck, preferably having at least partly a thickness larger than a corresponding distance between the relevant side of the lid and the relevant element extending from the neck, so as to force the relevant element away from the lid, pulling the body towards the lid.

7. Tapping assembly according to claim 1, wherein the lid has a peripheral edge forming part of a closure and sealing of the pressure chamber.

8. Tapping assembly according to claim 1, wherein the container comprises a closure in and/or on the neck, comprising a valve for dispensing a beverage from the container, preferably by squeezing the boy of the container by pressurising the pressure chamber, wherein preferably the closure comprises a ring with an opening through which the valve extends.

9. Container for a tapping device, comprising a neck and a body, wherein the neck comprises a first flange extending outward and a second flange extending at least partially around the neck, wherein the first flange is closer to the body than the second flange, and the first flange extends further outward from the neck than the second flange, such that the second flange can be pushed through an opening through which the first flange cannot be pushed, wherein the facing surfaces of the first and second flanges are preferably inclined relative to each other, such that when an element is pushed in radial direction, relative to an axis of the neck against one of said surfaces, the container will be moved in an axial direction of said neck.

10. Container according to claim 9, wherein the first and second flange substantially concentrically extend around a longitudinal axis of the neck and are at least substantially circular, wherein in a view along the longitudinal axis of the neck the second flange falls within the first flange, wherein preferably the first flange has a diameter which is at least 10 millimetres larger than a diameter of the second flange.

11. Container according to claim 9, wherein the container has an internal volume over 5 litres, preferably at least about 10 litres, and the neck has an internal opening of more than 25 millimetres, preferably more than 50 millimetres, wherein a valve is provided in or on said neck, which valve preferably is mounted in or on a ring connected to the neck.

12. Container according to claim 9, wherein at least a body of the container has a wall comprising at least two layers, wherein a void can be provided between the two layers.

13. Preform for blow moulding a container, comprising a neck portion and a body portion, wherein the neck portion comprises a first flange extending at least partially around the neck and a second flange extending at least partially around the neck, wherein the first flange is closer to the body portion than the second flange, and the first flange extends further outward from the neck than the second flange, such that the second flange can be pushed through an opening through which the first flange cannot be pushed, wherein the facing surfaces of the first and second flanges are preferably inclined relative to each other, such that when an element is pushed in radial direction, relative to an axis of the neck against one of said surfaces, the preform will be moved in an axial direction of said neck.

14. Preform according to claim 13, wherein the first flange and the second flange extend substantially parallel to each other, substantially perpendicular to a longitudinal axis of the neck portion, wherein the distance between the first and second flange is smaller than a third of the average internal cross section of the neck portion, preferably less than a fourth, more preferably than a fifth, wherein the cross section is preferably more than about 25 millimetres, more preferably more than about 50 millimetres.

15. Method for tapping a beverage, wherein a lid of a pressure chamber is mounted on a neck of a container and the container is inserted into the pressure chamber, such that the lid closes off the pressure chamber at least partly, wherein the container is pulled with a first flange against a side of the lid facing the pressure chamber and locked in that position, thereby sealing an opening in the lid through which the neck of the container extends.
